(19) United States
(12) Patent Application Publication
(10) Pub. No.: US 2002/0088819 A1
(43) Pub. Date: Jul. 11, 2002

(54) Article-retrieving machine

(75) Inventor: Ming Shan Wei, Kaohsiung (TW)

Correspondence Address: Bacon & Thomas, 4th Floor, 625 Slaters Lane, Alexandria, VA, 22314, US

(73) Assignee: Paokai Electronic Enterprise Co. Ltd., Kaohsiung (TW)

(21) Appl. No.: 09/757,599

(22) Filed: Jan. 11, 2001

(51) Int. Cl. G07F 11/44

(52) U.S. Cl. 221/210; 221/155; 221/236; 221/270; 221/282

(57) ABSTRACT

An article-retrieving machine comprises a machine body having a slide guide mounted therein at a level higher than the articles in the machine body to be retrieved. When article is caught and falls onto the slide guide, the article slides downward to a rest portion. An ejector plate is mounted to an end of the slide guide and has an underside in rolling contact with a roller. The ejector plate is movable to push the articles on the rest portion toward a hole in the control box that communicates with an article-retrieving outlet in the machine body. A doorplate is provided to control opening/closing of a passage to the article-retrieving outlet under cooperation with a stop plate of the control box.

### BACKGROUND OF THE INVENTION

1. Field of the Invention

The present invention relates to an article-retrieving machine which can be used for freezing articles. The retrieving rate of the articles inside the machine is increased, yet tricky retrieval of the articles by means of tilting the machine is prevented.

2. Description of the Related Art

FIG. 8 of the drawings illustrates a conventional article-retrieving machine comprising a transparent window 91 that encloses articles (such as various kinds of candies and toys) to be retrieved. A customer may insert a coin into the machine and operate buttons on the machine for moving a claw 92 to a desired position and the claw 92 is lowered for catching an article. Then, the claw 92 is elevated and moved to a position above an outlet opening 93 which is communicated with an article-retrieving outlet 94. Next, the customer operates one of the buttons to release the article caught by the claw 92, and the article reaches the article-retrieving outlet 94 via the outlet opening 93.

The most frequent situation during playing with the above-mentioned article-retrieving machine is that the article caught by the claw 92 falls during movement of the claw 92 before the claw 92 moves to a position above the outlet opening 93. The retrieving rate is thus low and the customer will be frustrated and not interested in playing again. In addition, the articles stored in the article-retrieving machine are usually candies, cookies, and toys, not frozen food, and the candies and cookies decay easily at normal temperature.

### SUMMARY OF THE INVENTION

It is an object of the present invention to provide an article-retrieving machine, wherein the caught article can be retained in a retrieved state to attract the customer to play again.

It is another object of the present invention to provide an article-retrieving machine which preserves frozen food or the like while eliminating loss of cooling air.

It is a further object of the present invention to provide an article-retrieving machine which can be moved easily and can be retained in place when necessary to thereby prevent retrieval of the articles in the machine by tilting.

An article-retrieving machine comprises a machine body having a slide guide mounted therein at a level higher than the articles in the machine body to be retrieved. When article is caught and falls onto the slide guide, the article slides downward to a rest portion. An ejector plate is mounted to an end of the slide guide and has an underside in rolling contact with a roller. The ejector plate is movable to push the articles on the rest portion toward a hole in the control box that communicates with an article-retrieving outlet in the machine body. A doorplate is provided to control opening/closing of a passage to the article-retrieving outlet under cooperation with a stop plate of the control box.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a perspective view of an article-retrieving machine in accordance with the present invention.

FIG. 2 is an exploded perspective view of a portion of the article-retrieving machine in FIG. 1 for immobilizing the article-retrieving machine.

FIG. 3 is an exploded perspective view of a slide guide and a control box of the article-retrieving machine in accordance with the present invention.

FIG. 4 is a top view of the slide guide and the control box in FIG. 3.

FIG. 5 is a sectional view taken along line 5-5 in FIG. 4.

FIG. 6 is a view similar to FIG. 5, wherein an article slides downward to a rest portion.

FIG. 7 is a view similar to FIG. 6, wherein the article falls from an outlet opening.

FIG. 8 is a perspective view of a conventional article-retrieving machine.

### DETAILED DESCRIPTION OF THE PREFERRED EMBODIMENTS

A preferred embodiment in accordance with the present invention will now be described with reference to the accompanying drawings.

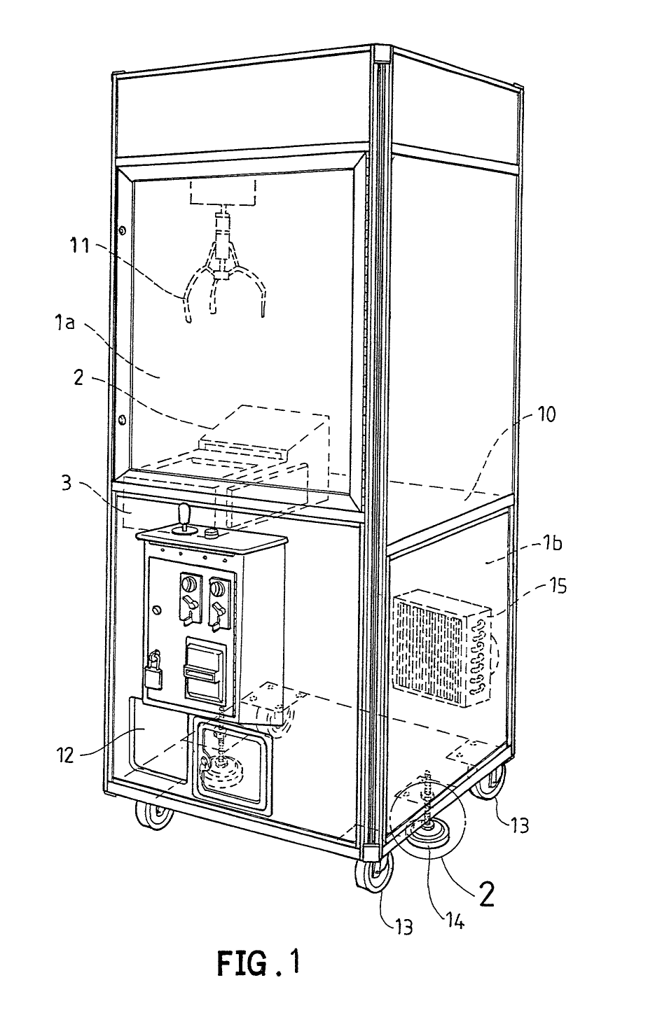

Referring to FIG. 1, an article-retrieving machine in accordance with the present invention generally includes a machine body 1 having a partition plate 10 that separates an interior of the machine body 1 into an upper storage space 1a and a lower machinery space 1b. The upper storage space 1a is provided for storing articles (such as frozen food or the like) to be retrieved, and a compressor 15 placed on top of the machine body 1 provides the required low-temperature environment in the upper storage space 1a, thereby keeping the articles at low temperature. The machine body 1 further includes an article-retrieving outlet 12 to allow removal of the article.

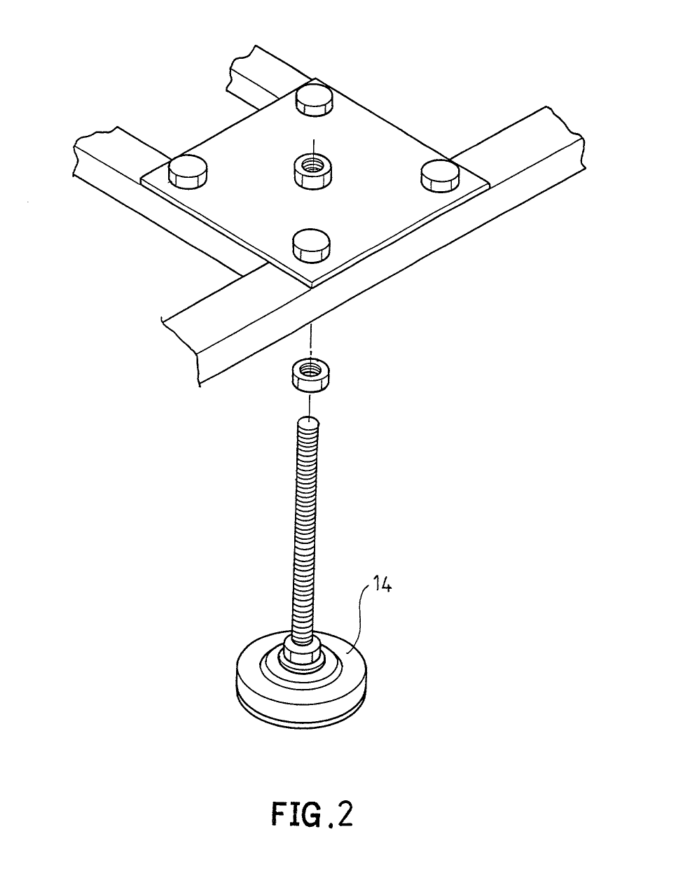

A claw 11 is mounted in the upper storage space 1a and can be operated to catch and pick up the articles placed on the partition plate 10. The caught article can be moved along with the claw 11 to a position above a slide guide 2, which will be described in detail later. The machine body 1 includes a plurality of casters 13 attached to an underside thereof to allow easy movement. As illustrated in FIG. 2, the machine body 1 further includes at least one adjusting seat 14 that can be adjusted to touch the ground and thus immobilize the machine body 1.

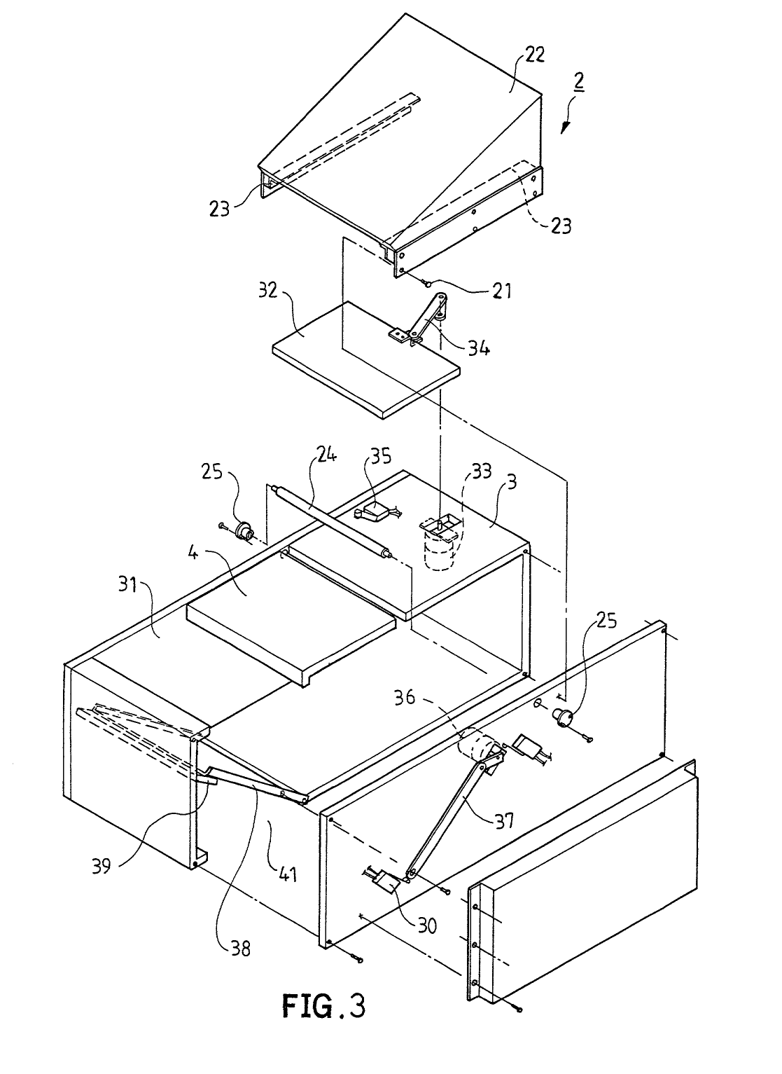

Referring to FIGS. 1 and 3, the slide guide 2 and a control box 3 are mounted in the machine body 1, wherein the former is fixed by fasteners 21 (such as screws) to an end of a rest portion 4 of the control box 3. The slide guide 2 is mounted to a higher level above the articles placed on the partition plate 10. The slide guide 2 includes an inclined surface 22 which is so arranged that an article fall onto the inclined surface 22 slides downward to the rest portion 4 located on top of the control box 3. The slide guide 2 further includes a pair of tracks 23 on lower ends of two lateral walls thereof, which will be described later.

The control box 3 is fixed in the machine body 1. The top of the control box 3 further includes an outlet opening 31 defined in a side of the rest portion 4. The slide guide 2 is mounted to the other side of the rest portion 4. An ejector plate 32 is slidably mounted above the rest portion 4 and driven by a power element 33 via a link 34. Namely, when the power element 33 operates, the ejector plate 32 slides over the rest portion 4 to push the article on the rest portion 4 into the outlet opening 31 that communicates with the article-retrieving outlet 12 of the machine body 1. The sliding motion of the ejector plate 32 is guided in a horizontal direction by the tracks 23 in the slide guide 2. In order to provide stable, smooth sliding motion of the ejector plate 32, a roller 24 is rotatably mounted in the rest portion 4 with a portion of the roller 24 extending beyond the surface of the rest portion 4 for rolling contact with an underside of the ejector plate 32. Each of two ends of the roller 24 is rotatably mounted in an axle sleeve 25 that is fixed to a respective side of the control box 3. Thus, only a minor friction exists during sliding movement of the ejector plate 32. After a sliding travel, the ejector plate 32 impinges a sensing element 35 which sends out a signal to stop the power element 33.

The control box 3 further includes a power element 36 that controls opening/closing of a doorplate 38 via a link 37. As illustrated in FIG. 5, when the doorplate 38 is in contact with a stop plate 39 extending inward from an inner wall of the control box 3, the outlet opening 31 of the control box 3 is not communicated with a hole 41 in a bottom wall (not labeled) of the control box 3, which, in turn, communicates with the article-retrieving outlet 12. Thus, tricky retrieval of the articles in the machine body 1 by tilting the machine body 1 would fail, as the articles still remain in an interior of the control box 3. The doorplate 38 also prevents escape of cooling air via the hole 41. When the doorplate 38 is driven by the power element 36 and thus moves away from the stop plate 39, the caught article may fall to the article-retrieving outlet 12 of the machine body 1 via the hole 41 of the control box 3. Operation of the power element 36 can be controlled by a sensing element 30 fixed to a side wall (not labeled) of the control box 3. Namely, when the claw 11 catches an article, the doorplate 38 is moved to its open position and remains there.

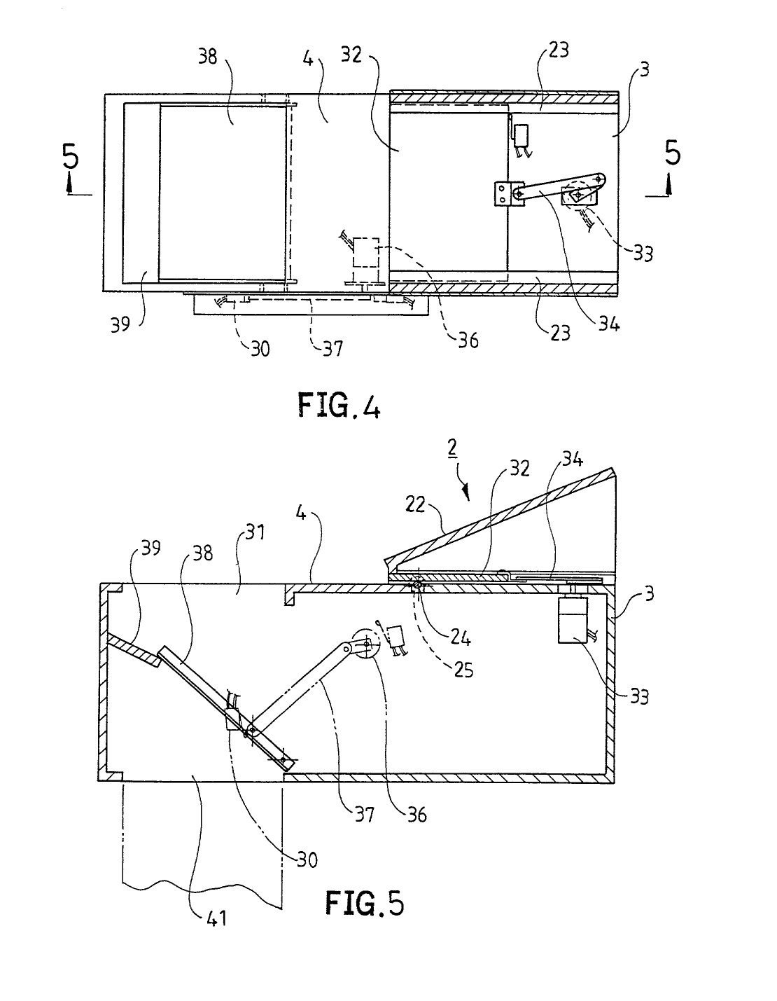

Referring to FIGS. 4 and 5, the ejector plate 32 is initially in an inner side of the slide guide 2 before operation of the claw 11. An end of the doorplate 38 is in contact with the stop plate 39 and the other end of the doorplate 38 rests on the bottom wall of the control box 3. Thus, passage for the article to the article-retrieving outlet 12 via the hole 14 is closed.

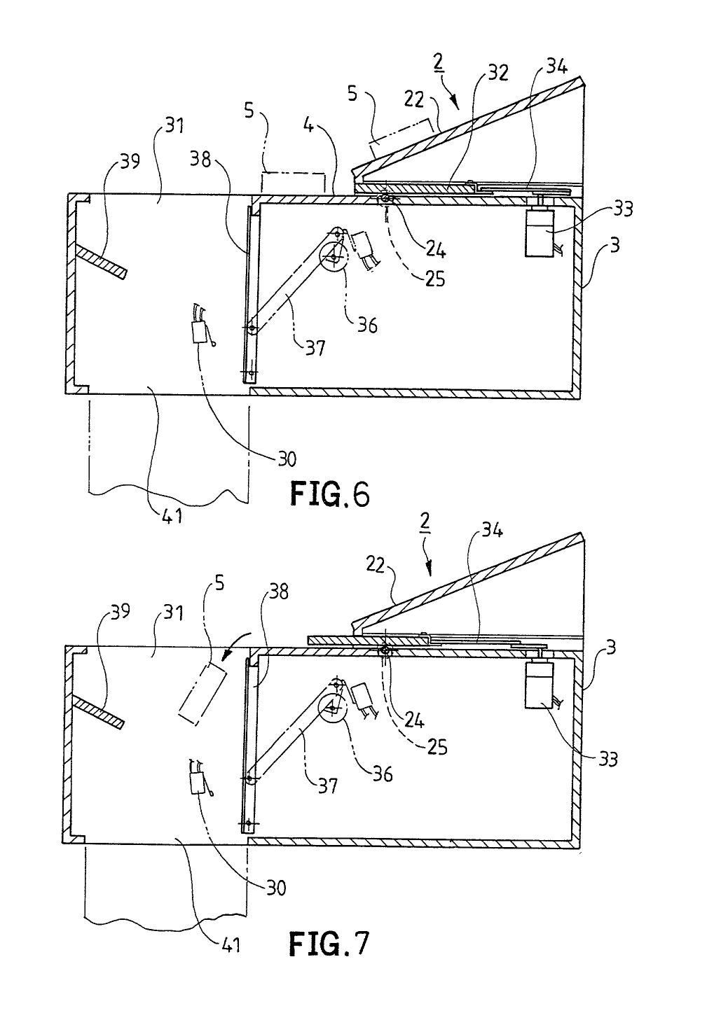

Referring to FIG. 6, when the claw 11 is operated to catch an article among those placed on the partition plate 10, the caught article 5 falls to the inclined surface 22 of the slide guide 2 if the claw 11 carrying the caught article 5 reaches a position above the inclined surface 22 and the claw 11 is operated to release the caught article 5. The caught article 5 slides downward to the rest portion 4 on top of the control box 3 due to gravity The doorplate 38 is driven by the power element 36 and leaves the stop plate 39 to the open position. Thus, passage for the article 5 to the article-retrieving outlet 12 via the hole 14 is now open.

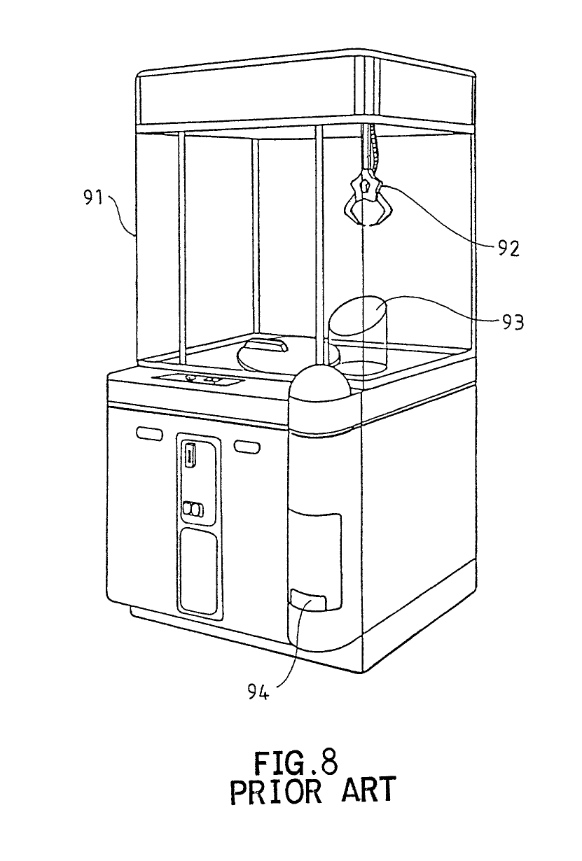

Referring to FIG. 7, during movement of the doorplate 38 to its open position, the ejector plate 32 is driven by the power element 33 to slide over the rest portion 4 of the control box 4 and thus pushes the article 5 on the rest portion 4 into the outlet opening 31. Thus, the article 5 falls to the article-retrieving outlet 12 of the machine body 1 via the hole 41 in the control box In accordance with the feature recited in claim 1 of the present invention, the caught article 5 may rest on the rest portion 4 to attract the customer to play one more time. In addition, the partition plate 10 separates the machine body 1 into the upper storage space 1a and the lower machinery space 1b. The doorplate 38 controlling opening of passage for the article 5 to the article-retrieving outlet 12 of the machine body 1 is normally closed to prevent leakage of large amount of cooling air when the upper storage space 1a is provided for frozen food or the like. The machine body functions well in preserving frozen food. Furthermore, the doorplate 38 is normally in its closed position and thus prevents tricky customer that tries to retrieve the articles by tilting the machine body 1. The caught articles will remain in the control box even through the tricky customer tilts the machine body 1, as the passage to the article-retrieving outlet 12 of the machine body 1 is closed.

In accordance with the feature recited in claim 2 of the present invention, the ejector plate 32 is not in contact with the rest portion 4 of the control box 3 during sliding movement of the ejector plate 32. The ejector plate 32 is in rolling contact with the roller 24 and thus has a small friction to thereby provide a stable, smooth sliding.

In accordance with the feature recited in claim 3 of the present invention, two ends of the roller 24 are rotatably mounted in two axle sleeves, respectively. Thus, the roller 24 rotates during sliding movement of the ejector plate 32, thereby further assuring stable, smooth sliding of the ejector plate 32.

In accordance with the feature recited in claim 4 of the present invention, sliding movement of the ejector plate 32 is guided in a horizontal direction by tracks.

In accordance with the feature recited in claim 5 of the present invention, the machine body has casters 13 attached to an underside thereof for easy movement to a desired place. In addition, the machine body can be immobilized to prevent undue tilting when necessary.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. An article-retrieving machine comprising:
a machine body comprising a claw therein for catching articles in the machine body, the claw is capable of catching at least one of the articles in the machine body and releasing said at least one of the articles to a predetermined position, the machine body further including an article-retrieving outlet for retrieving the articles;
a slide guide mounted in the machine body and including an inclined surface for guiding said at least one of the articles caught by the claw to slide downward; and
a control box including a top having a rest portion, the rest portion having a first end engaged with the slide guide and a second end in which an outlet opening is defined, a first power element being mounted in the control box for moving an ejector plate for pushing said at least one of the articles on the rest portion into the outlet opening, the control box further including a stop plate, the control box further including a hole that is located between the outlet opening of the control box and the article-retrieving outlet of the machine body, a doorplate being mounted in the control box for controlling communication between the outlet opening of the control box and the article-retrieving outlet of the machine body under cooperation with the stop plate, a second power element being mounted in the control box for controlling opening and closing of the doorplate;
wherein the doorplate is normally in a close position that does not allow passage of said at least one of the articles on the rest portion from the outlet opening of the rest portion to the article-retrieving outlet via the hole; and
wherein when the doorplate is moved to an open position by the second power element, said at least one of the articles on the rest portion is passable from the outlet opening of the rest portion to the article-retrieving outlet via the hole.

2. The article-retrieving machine as claimed in claim 1, wherein the rest portion includes a roller protruded therefrom for rolling contact with an underside of the ejector plate.

3. The article-retrieving machine as claimed in claim 2, wherein the control box further including two axle sleeves fixed thereto for rotatably receiving two ends of the roller, respectively.

4. The article-retrieving machine as claimed in claim 1, wherein the slide guide includes a pair of tracks on lower ends of two lateral sides thereof for guiding sliding movement of the ejector plate.

5. The article-retrieving machine as claimed in claim 1, wherein the machine body includes at least one adjusting seat that can be either adjusted to touch ground to thereby immobilize the machine body or adjusted to leave the ground for moving the machine body.
